(19) United States
(12) Patent Application Publication
(10) Pub. No.: US 2014/0152845 A1
(43) Pub. Date: Jun. 5, 2014

(54) camera testing device and method for testing a camera

(71) Applicants: Ulrich Seger, Leonberg-Warmbronn (DE); Uwe Apel, Neckartailfingen (DE); Carina Raizner, Noerdlingen (DE)

(72) Inventors: Ulrich Seger, Leonberg-Warmbronn (DE); Uwe Apel, Neckartailfingen (DE); Carina Raizner, Noerdlingen (DE)

(21) Appl. No.: 14/117,780

(22) PCT Filed: Mar. 20, 2012
(86) PCT No.: PCT/EP2012/054895

§ 371 Date: Feb. 14, 2014

(30) Foreign Application Priority Data
May 19, 2011 (DE) 10 2011 076 133.0

(51) Int. Cl. H04N 17/00

(52) U.S. Cl. CPC H04N 17/002
USPC 348/188

(57) ABSTRACT

A testing device for a camera, in particular of driver assistance systems in a motor vehicle, including a mount for a camera and at least two light sources for emitting test light toward the camera, the mount and at least one of the at least two light sources being situated fixed in relation to one another with respect to their relative location and position, and a control device which is configured to activate the at least two light sources in such a way that in chronological sequence one light source is switched on and the at least one other light source is switched off. Also described is a related testing method for a camera and a testing system.

### FIELD OF THE INVENTION

The present invention relates to a camera testing device and a method for testing a camera. The present invention also relates to the use of a testing device and to a testing system.

### BACKGROUND INFORMATION

Cameras are used in a variety of ways in the related art, among other things in automotive engineering. They may be used, for example, in conjunction with driver assistance systems, to observe the road area ahead of a motor vehicle. Such cameras are highly dynamic and have a wide brightness range, in order to allow recordings of the desired quality both in the daytime and at night. Due to their wide brightness range, such cameras are sensitive to faults in their lens system, causing stray or parasitic light. Faults in the lens system may be caused by reflections from the mount, faults in the lens coating, particles or scratches. The stray or parasitic light may then appear in the camera's image field in the form of image artifacts. Image artifacts may occur at various places in the camera's image field and are perceived by observers of the image as objectionable or quality-debasing. In addition, it is possible for the parasitic light to cause overexposure of certain details and/or darker objects, which are then no longer perceptible in the image recorded by the camera.

In order to test such a high-dynamic camera for faults in its lens system, normally the camera is irradiated in a dark environment with light from a light source and the resultant image recorded by the camera of the light source is evaluated. In this process the high-dynamic camera is rotated or tilted so that its entire image area is irradiated with light from the light source and the resultant image recorded by the high-dynamic camera may be evaluated. In order to evaluate the image recorded by the high-dynamic camera a visual inspection is carried out by an observer, who examines the image recorded by the high-dynamic camera for image artifacts, the image being displayed on a screen, for example. This examination is based on a failure catalog, showing those faults which are typical. The observer then evaluates the corresponding image artifacts, based on the failure catalog. Fault criteria are, for example, brightness, width and/or length of the coronal beams emitted from a location of the light source.

### SUMMARY OF THE INVENTION

In one exemplary embodiment, a testing device is defined for a camera, in particular for driver assistance systems in a motor vehicle, including a mount for a camera, at least two light sources for emitting test light toward the camera, the mount and at least one of the at least two light sources being situated fixed in relation to one another with respect to their relative location and position, and a control device which is configured to activate the at least two light sources in such a way that in chronological sequence one light source is switched on and the at least one other light source is switched off, and the control device being configured to activate the at least two light sources synchronously with an image capture of an image of the camera.

In another exemplary embodiment, a testing method is defined for a camera, in particular for driver assistance systems in a motor vehicle, which may be suitable for execution on a testing device as described herein, including the steps: fitting the camera in a mount, emitting test light toward the camera with the aid of at least two light sources, recording the test light by the camera, and evaluating the recorded test light, the mount and at least one of the at least two light sources being situated fixed in relation to one another with respect to their relative location and position and the at least two light sources being activated in such a way that in chronological sequence one light source is switched on and the at least one other light source is switched off and the at least two light sources being activated synchronously with an image capture of an image of the camera.

In another exemplary embodiment, a testing system for an at least partially transparent object is defined, including a testing device as described herein, a camera and a mount for an at least partially transparent object to be tested, the mount being situated in the light path between the at least two light sources and the camera, and an evaluation unit, which is connected to the camera for evaluating, in particular automatically, the test light recorded by the camera.

The testing device, the testing method and the testing system have the advantage that they permit a test of a high-dynamic camera and/or of an at least partially transparent object to be carried out easily and rapidly. In addition, the testing system and the testing device may have a more compact design.

Advantageous refinements of the present invention are described in the further descriptions herein.

According to one advantageous refinement of the present invention, at least one of the at least two light sources includes a collimating device and/or is configured as a light-emitting diode. The advantage gained thereby is that this design provides an even more compact device. In addition, light-emitting diodes may be switched on and off faster, and generate a more stable light with respect to intensity and wavelength, compared to conventional light sources.

According to one further advantageous refinement of the present invention, an evaluation unit which is connectable to a camera to be tested is situated for automatic evaluation of the test light received by the camera. The advantage gained thereby is that this allows faults in the camera or image artifacts to be evaluated rapidly and inexpensively, in a simple and reliable manner.

According to one further advantageous refinement of the present invention, a light path between the respective light sources and the camera is essentially the same. This feature ensures that the camera is irradiated by each of the light sources at the same intensity, thereby making possible a maximum degree of reliability and accuracy in the evaluation of images of the camera with the aid of the light sources, and thus enabling the detection of image artifacts.

According to one further advantageous refinement of the present invention, the light path is shorter than 75 cm, in particular shorter than 50 cm, and which may be shorter than 40 cm. This feature permits an extremely compact testing device to be provided.

According to one further advantageous refinement of the present invention, the at least two light sources are arranged in a regular pattern, in particular in the form of a grid. In this way, the light sources create, in the image recorded by the camera, a regular grid pattern of spots of the respective light sources, thereby simplifying the testing of the camera for image artifacts.

According to a further advantageous refinement of the testing system, the at least two light sources and the camera to be tested are situated in such a way that the light sources are arranged in a regular grid pattern on an image of test light from the light sources recorded by the camera. In this way, the light sources create, in the image recorded by the camera, a regular grid pattern of spots of the respective light sources, thereby simplifying the testing of the camera for image artifacts.

According to one further advantageous refinement of the testing system, the mount is fitted movably and is controllable in particular with the aid of the control device. The advantage gained by this feature is that the entire image recorded by the camera of the test light transmitted by the at least partially transparent object may be examined easily and rapidly, and in particular in an automated way, for possible image artifacts, enabling conclusions to be drawn concerning, for example, a surface condition of the at least partially transparent object.

According to one further advantageous refinement of the present invention, the camera has a dynamic range of at least 10⁴, in particular at least 10⁵, which may be 10⁷. The advantage gained by this feature is that thereby surface defects of lenses, their degree of coating, etc., may be examined even more easily with the aid of the testing system.

Further features and advantages of the present invention arise from the description below of exemplary embodiments, based on the drawings.

### BRIEF DESCRIPTION OF THE DRAWINGS

FIG. 1 shows a cross section of a testing device according to one first specific embodiment of the present invention in schematic form.

FIG. 2 shows an image recorded by a camera to be tested of a light source using a testing device according to FIG. 1.

FIG. 3 shows a light source with a collimating device of a testing device according to FIG. 1.

### DETAILED DESCRIPTION

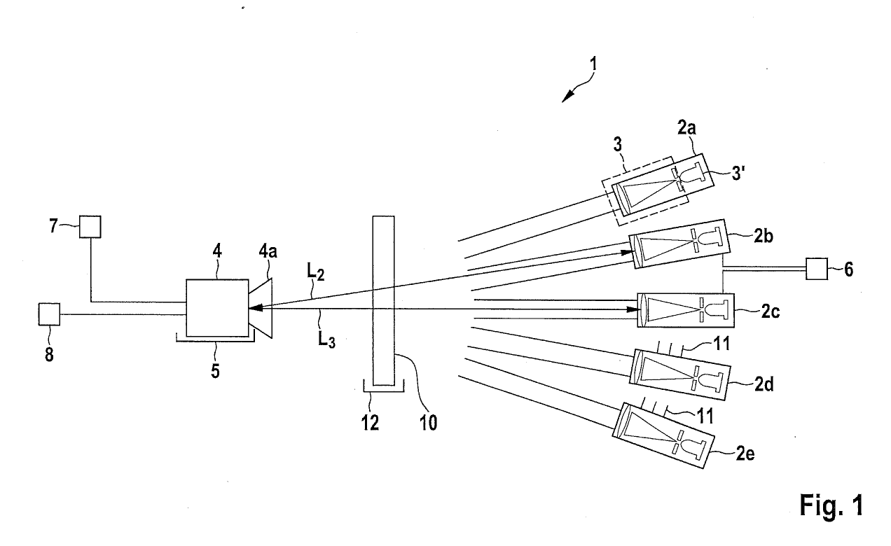

FIG. 1 shows a cross section of a testing device according to one first specific embodiment of the present invention in schematic form.

In FIG. 1, reference numeral 1 identifies a testing device for a camera 4, which includes a lens 4a. Camera 4 is connected to an evaluation unit 7, 8, reference numeral 7 identifying an evaluation unit which automatically evaluates an image recorded by camera 4. Reference numeral 8 identifies a monitor on which the image from camera 4 and, if necessary, the evaluated results of evaluation unit 7 are displayed for a user. Camera 4 is situated in a mount 5, which in particular is situated fixed with respect to light sources 2a through 2e. Light sources 2a through 2e are arranged at least partially in a circle around imaging lens 4a of camera 4, allowing them to act upon camera 4 with lights L₂, L₃ respectively. Light sources 2a through 2e each include a collimating device 3, which essentially parallelizes light from a light-emitting diode 3′ in order to act upon imaging lens 4a of camera 4 with light.

Light sources 2a through 2e are each connected to a control device 6. FIG. 1 shows a connection of light sources 2b and 2c to control device 6. Of course, the other light sources 2a, 2d and 2e are also each connected to control device 6.

In order for camera 4 to be able as reliably as possible to take in only the light from light sources 2a through 2e, the testing device is in particular configured in such a way that background irradiation, such as for example in the case of reflections from imaging lens 4a, which may strike imaging lens 4a a second time from the walls of testing device 1, are reduced as far as possible. For this purpose, vanes 11, for example, are situated on the light sources to prevent such backscatter. This improves the recognition of image artifacts in an image recorded by camera 4. For this purpose testing device 1 is configured in such a way that a radiation power of less than 0.1%, in particular less than 0.05%, which may be less than 0.02%, of the radiance of a light source 2a through 2e is reflected from darker areas in testing device 1.

In this context, control device 6 is also configured in such a way that it may control light sources 2a through 2e in such a way that a respective light field of light sources 2a through 2e, their brightness and/or saturation may be changed or adapted. In addition, light sources 2a through 2e are configured as stabilizable light sources 2a through 2e, in other words they have an essentially constant radiation power in a predefined wavelength band. Control device 6 is also connected to evaluation unit 7 and configured in such a way that control device 6 synchronizes the switching on and off of light sources 2a through 2e with the image capture of camera 4 during image recording.

In order to test camera 4 fitted in mount 5 for optical artifacts, etc., light sources 2a through 2e are now sequentially each switched on individually for a predefined period of time, and using the image recorded by camera 4, for example with the aid of monitor 8, are analyzed whether and/or to what extent image artifacts are present in the images recorded by camera 4. The analysis is advantageously carried out with the aid of computer-assisted image processing; in particular, the evaluation of an image recorded by camera 4 of a light source 2a through 2e takes place in real time and thus permits an extremely rapid and objective assessment of stray light artifacts in the lens system. For this purpose, image artifacts may be ascertained with regard to their characteristic properties, such as, for example, length, thickness and angle of a beam-shape image artifact, with the aid of automated processing, for example using a bright/dark comparison of surrounding pixels arranged in a grid pattern, and these may then be classified on the basis of a failure catalog. If then, for example, a classification number is assigned to each image artifact, the classification number and/or a total of classification numbers of different types of image artifacts may be used to determine whether or not the camera meets a desired freedom from faults.

These results of the analysis of stray light artifacts which possibly occur in the lens system of camera 4 are buffered in evaluation unit 7 and are used later as references when at least partially transparent objects 10 in the beam path between light sources 2a through 2e and camera 4 are examined. After the analysis and evaluation of stray light artifacts of camera 4, testing device 1 is calibrated and may then be used for measuring surface defects of at least partially transparent objects 10. In this way, their degree of coating, resulting for example from condensation, dirt or ice, etc., may also be analyzed, or levels of quality of lenses are identified. When the at least partially transparent object 10, which is situated in a mount 12, is acted upon, scratch marks, for example, on a lens appear in the image of light sources 2a through 2e as radially symmetrical beams away from the center of the image of the photographed light sources 2a through 2e. In this process, possible stray light artifacts in imaging lens 4a of camera 4, which were buffered during the previous calibration of testing device 1, are appropriately taken into account in the evaluation of the at least partially transparent object 10 and in particular eliminated in the analysis.

It is also possible to use testing device 1 to measure a manufacturing quality, for example polishing grades, etc., of optical surfaces, since the latter modify the stray light characteristics in the optical path between light sources 2a through 2e and camera 4. Finally, lens reflections may also be measured, which may result in a decrease in lens performance in cameras in high-dynamic applications. Such applications are, for example, vehicle-mounted cameras in driver assistance systems or security cameras, whose effectiveness, for example, may be severely impaired or reduced by shafts of sunlight penetrating into their visual field. It is also possible, if the lens has an anti-reflection coating, to test and/or to determine the quality of the coating on the basis of a stray light test carried out using testing device 1.

FIG. 1 shows a vehicle windshield 10 as an at least partially transparent object. This, in testing device 1, is inserted into the optical path between light sources 2a through 2e and camera 4, in order to detect defects, dirt or wear on windshield 10. As described above, light sources 2a through 2e are switched on alternately, and the transmission of the light from light sources 2a through 2e through windshield 10 is recorded by camera 4, and evaluated. If the image recorded with the aid of camera 4 shows stray light artifacts, a defect is possibly detected. In this process, control device 6, which is connected to evaluation unit 7, is configured in such a way that control device 6 synchronizes the image capture of camera 4 and the switching on and off of light sources 2a through 2e.

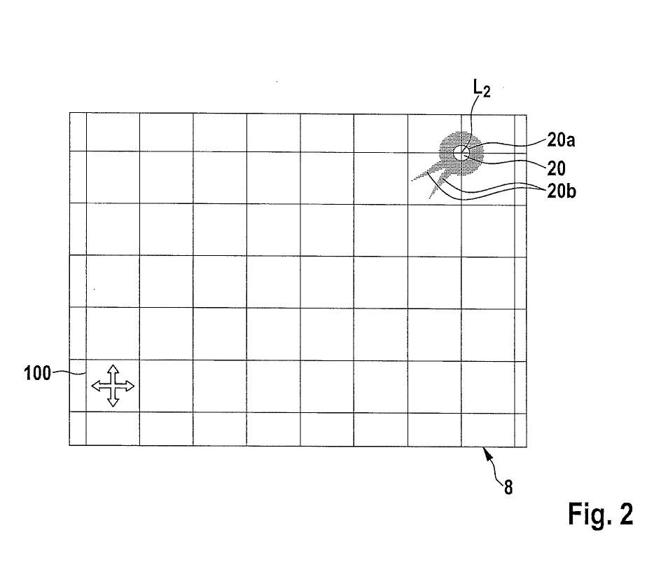

FIG. 2 shows an image of a light source recorded by a camera to be tested using a testing device according to FIG. 1.

FIG. 2 shows an image of light source 2b recorded with the aid of camera 4, displayed on a monitor 8. A grid pattern 100 is apparent in the image, essentially square in shape and laid over the image, each intersection of the grid essentially corresponding to a light source 2a through 2e. The recorded light L₂ from light source 2b is shown in the top right area of

FIG. 2. In the middle of the recorded light an essentially symmetrical bright spot 20 is visible, which has an essentially circular corona 20a. Furthermore, two beams 20b standing out from the dark background are shown, pointing in the radial direction toward the bottom left of FIG. 2. These deviate from the ideal light distribution of light source 2b, namely a radially symmetrical distribution, and thus reveal a stray light artifact. Depending on the length, thickness and/or angle of beams 20b, this is classified as an image distortion or stray light artifact.

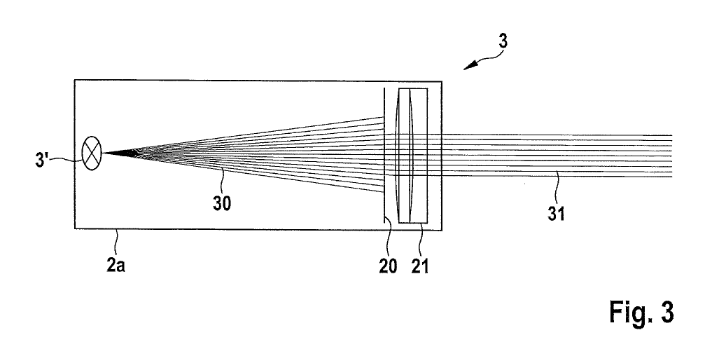

FIG. 3 shows a collimating device for a light source of a testing device according to FIG. 1.

FIG. 3 shows a light source 2a with a collimating device 3. Light source 2a includes in a housing a light-emitting diode 3′, which irradiates light 30 essentially in the radial direction. Beams of light 30 are consequently not parallel. The beams then strike a collimating device 3, including a screen 20, which blanks out the outer light beams, in other words beams which are further away from the center of the screen than specified. The remaining light beams 30 pass through screen 20 and reach a lens 21, in particular an achromatic NIR lens. After the light beams have passed through lens 21 they are then essentially parallel (identified in FIG. 3 by reference numeral 31).

Overall, the present invention presents several advantages. The present invention makes possible the reliable measurement of lens reflections which in particular result in a decrease in the performance of the lens in high-dynamic applications. At the same time the present invention makes it possible to test cameras, lenses, cover slips, cover plates or at least partially optically transparent and/or reflecting boundary surfaces for optical faults and to evaluate them using parasitic and/or stray light. In addition it is possible to examine coatings and polishing grades of surfaces or coatings, for example in the case of anti-reflection coatings. A further advantage is that a simple and reliable test may be carried out objectively and rapidly with the aid of the testing device or the testing system, as the case may be.

Although the present invention has been described above on the basis of exemplary embodiments, it is not limited thereto, but is modifiable in a variety of ways.

1-11. (canceled)

12. A testing device for a camera, of a driver assistance system in a motor vehicle, comprising:
a mount for a camera;
at least two light sources to emit test light towards the camera, wherein the mount and at least one of the at least two light sources are situated fixed in relation to one another with respect to their relative location and position; and
a control device to activate the at least two light sources so that in chronological sequence one light source is switched on and the at least one other light source is switched off, wherein the control device is configured to activate the at least two light sources synchronously with an image capture of an image of the camera.

13. The testing device of claim 12, wherein at least one of the at least two light sources at least one of includes a collimating device and a light-emitting diode.

14. The testing device of claim 13, further comprising:
an evaluation unit, connectable to a camera to be tested, to automatically evaluate the test lights received by the camera.

15. The testing device of claim 12, wherein light paths between the respective light sources and the camera are essentially the same.

16. The testing device of claim 12, wherein the light paths are shorter than 75 cm.

17. The testing device of claim 12, wherein the at least two light sources are arranged in a regular pattern, in the form of a grid.

18. A testing method for a camera, for a camera in a driver assistance system in a motor vehicle and for execution on a testing device, the method comprising:
fitting the camera in a mount of the testing device, wherein the testing device includes the mount for the camera, at least two light sources to emit test light towards the camera, and a control device to activate the at least two light sources;
emitting test lights toward the camera with the aid of the at least two light sources;
recording the test lights by the camera; and
evaluating the recorded test lights;
wherein the mount and at least one of the at least two light sources are situated fixed in relation to one another with respect to their relative location and position, and wherein the at least two light sources are activated so that in chronological sequence one light source is switched on and the at least one other light source is switched off and the at least two light sources are activated synchronously with an image capture of an image of the camera.

19. A testing system for an at least partially transparent object, comprising:
a testing device for a camera, of a driver assistance system in a motor vehicle, including a mount for the camera, at least two light sources to emit test light towards the camera, wherein the mount and at least one of the at least two light sources are situated fixed in relation to one another with respect to their relative location and position, and a control device to activate the at least two light sources so that in chronological sequence one light source is switched on and the at least one other light source is switched off, wherein the control device is configured to activate the at least two light sources synchronously with an image capture of an image of the camera;
the camera;
a mount for the at least partially transparent object to be tested, wherein the mount is situated in the light path between the at least two light sources and the camera; and
an evaluation unit, which is connected to the camera, to evaluate automatically the test light recorded by the camera.

10. The testing system of claim 19, wherein the at least two light sources and the camera to be tested are situated so that the light sources are arranged in a regular grid pattern on a recording of the test lights by the camera.

21. The testing system of claim 19, wherein the mount is fitted movably and is controllable with the aid of the control device.

22. The testing system of claim 19, wherein the camera has a dynamic range of at least 104.

23. The testing system of claim 19, wherein the camera has a dynamic range of at least 105.

24. The testing system of claim 19, wherein the camera has a dynamic range of at least 107.

25. The testing device of claim 12, wherein the light paths are shorter than 50 cm.

26. The testing device of claim 12, wherein the light paths are shorter than 40 cm.
